(19) United States
(12) Patent Application Publication
(10) Pub. No.: US 2006/0100887 A1
(43) Pub. Date: May 11, 2006

(54) Apparatus, system, and method for a motion based business decision

(76) Inventors: David Edward Erickson, Cary, NC (US); Joseph Wayne Freeman, Raleigh, NC (US); Isaac Karpel, Cary, NC (US); Hiroaki Mine, Yamato-shi (JP); James Stephen Rutledge, Durham, NC (US); Randall Scott Springfield, Chapel Hill, NC (US)

Correspondence Address: KUNZLER & ASSOCIATES, 8 EAST BROADWAY, SUITE 600, SALT LAKE CITY, UT, 84111, US

(21) Appl. No.: 10/984,420

(22) Filed: Nov. 9, 2004

(51) Int. Cl. G06Q 99/00; G07G 1/00; G06F 17/30

(52) U.S. Cl. 705/1; 705/10

(57) ABSTRACT

An apparatus, system, and method are disclosed for making a motion based business decision. A motion module senses a component of motion such as acceleration or a derivative of acceleration. A log module calculates a motion summary from the motion component and stores the motion summary in a memory module. An analysis module receives the motion summary and makes a business decision based on the motion summary.

### BACKGROUND OF THE INVENTION

1. Field of the Invention

This invention relates to making a business decision and more particularly relates to making a motion based business decision.

2. Description of the Related Art

Portable electronic devices such as laptop computers, cellular telephones, and personal digital assistants frequently include motion sensitive devices. Motion sensitive devices may be prone to damage from motion events such as an acceleration event. For example, a laptop computer may include a hard disk drive. The hard drive may be prone to damage from a major acceleration event such as the impact of the laptop computer when dropped.

The manufacturers of portable electronic devices typically warranty the portable electronic devices from component failures and defects in workmanship for a warranty period. Yet a manufacturer may decline to warranty a portable electronic device for damage from a motion event that the portable electronic device is not designed to withstand, such as the major acceleration event of a drop. Unfortunately, a motion event such as major acceleration event may damage a motion sensitive device in a portable electronic device but otherwise leave no evidence of the motion event. A manufacturer may be required to bear the cost of damage that violates the warranty of the portable electronic device when the user of the portable electronic device had violated the warranty such as by dropping the portable electronic device.

From the foregoing discussion, it should be apparent that a need exists for an apparatus, system, and method that detects and records a motion event and uses the motion event record to make a business decision. Beneficially, such an apparatus, system, and method would reduce warranty costs to manufacturers and consumers.

### SUMMARY OF THE INVENTION

The present invention has been developed in response to the present state of the art, and in particular, in response to the problems and needs in the art that have not yet been fully solved by currently available methods of making motion damage based business decisions. Accordingly, the present invention has been developed to provide an apparatus, system, and method for making a motion based business decision that overcome many or all of the above-discussed shortcomings in the art.

The apparatus to make a business decision is provided with a logic unit containing a plurality of modules configured to functionally execute the necessary steps of making a motion based business decision. These modules in the described embodiments include a motion module, a log module, a memory module, and an analysis module.

The motion module is configured to sense a motion component. In one embodiment, the motion component is acceleration and the motion module is an accelerometer. In an alternate embodiment, the motion component is the derivative of acceleration with respect to time. The log module calculates a motion summary from the motion component. In one embodiment, the log module is configured to detect a major acceleration event. The log module may calculate the motion summary as the sum of the magnitudes of the major acceleration events. In an alternate embodiment, the log module calculates the motion summary as the sum of the major acceleration events.

The memory module stores the motion summary. The analysis module makes a business decision based on the motion summary. In one embodiment, the analysis module voids a warranty based on the motion summary. In a certain embodiment, a communications module communicates the motion summary to the analysis module. The apparatus makes a business decision based on a motion summary such as voiding a warranty.

A system of the present invention is also presented to make a business decision. The system may be embodied in a portable electronic device such as a laptop computer. In particular, the system, in one embodiment, includes a motion sensitive device, a motion module, a log module, a memory module, a communication module, and an analysis module.

The motion sensitive device is susceptible to motion caused damage. In one embodiment, the motion sensitive device is susceptible to the acceleration caused by the impact of a drop. The motion module senses a motion component such as the acceleration caused during the drop. The log module calculates a motion summary from the motion component. The memory module stores the motion summary and the communication module communicates the motion summary to the analysis module. The analysis module makes a business decision based on the motion summary.

A method of the present invention is also presented for making a business decision. The method in the disclosed embodiments substantially includes the steps necessary to carry out the functions presented above with respect to the operation of the described apparatus and system. In one embodiment, the method includes sensing a motion component, calculating a motion summary, storing the motion summary, and making a business decision based on the motion summary.

A motion module senses a motion component. A log module calculates a motion summary from the motion component. A memory module stores the motion summary and an analysis module makes a business decision based on the motion summary.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention makes a business decision based on a motion summary calculated from a motion component. In addition, the present invention may reduce warranty costs for manufacturers and consumers by detecting damage from motion events that violate a warranty. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a business decision system in accordance with the present invention;

FIG. 2 is a schematic block diagram illustrating one embodiment of a business decision apparatus of the present invention;

FIG. 3 is a schematic block diagram illustrating one embodiment of a laptop computer of the present invention;

FIG. 4 is a schematic flow chart diagram illustrating one embodiment of a business decision method in accordance with the present invention;

FIG. 5 is a schematic flow chart diagram illustrating one embodiment of a motion summary evaluation method in accordance with the present invention; and

FIG. 6 is front view drawing of a communication system of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

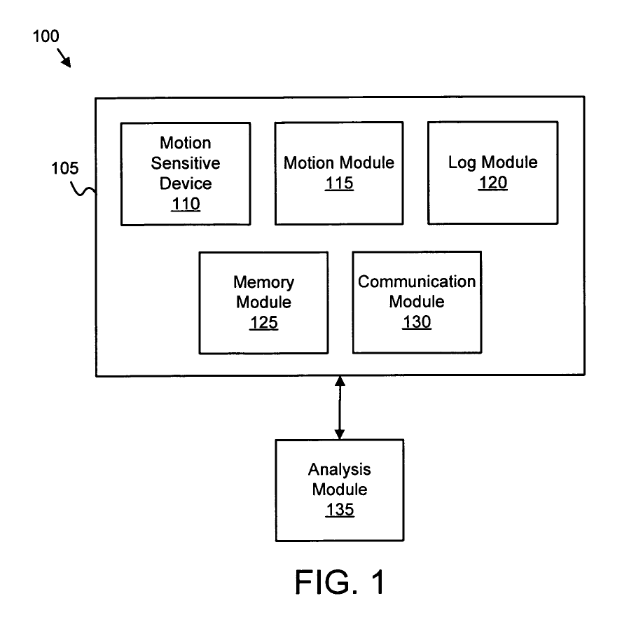

FIG. 1 is a schematic block diagram illustrating one embodiment of a business decision system 100 of the present invention. The system 100 includes a motion sensitive device 110, a motion module 115, a log module 120, a memory module 125, a communication module 130, and an analysis module 135. In the depicted embodiment, a portable electronic device 105 comprises the motion sensitive device 110, the motion module 115, the log module 120, the memory module 125, and the communication module 130. The portable electronic device 105 may be laptop computer, cellular telephone, personal digital assistant, global positioning system, or the like. In one embodiment, a computer, a portable digital assistant, or the like comprise the analysis module 135. Although the system 100 is depicted with the motion sensitive device 110, the motion module 115, the log module 120, the memory module 125, communication module 130, and analysis module 135 distributed among two devices, the motion sensitive device 110, the motion module 115, the log module 120, the memory module 125, communication module 130, and analysis module 135 may be distributed among any number of devices.

The motion sensitive device 110 is susceptible to damage from one or more components of motion, such as acceleration, the derivative of acceleration with respect to time, or the like. For example, the motion sensitive device 110 may be susceptible to the acceleration caused by the impact of a drop. The motion sensitive device 110 may be a hard disk drive, liquid crystal display, laser gyroscope, or the like. A manufacturer may warranty the portable electronic device 105 including the motion sensitive device 110, but exclude motion damage such as damage caused by excessive acceleration. In addition, the manufacturer may desire to void a warranty if the portable electronic device 105 is dropped.

The motion module 115 senses a motion component such as the acceleration caused by a drop. The log module 120 calculates a motion summary from the motion component. The memory module 125 stores the motion summary. In one embodiment, the memory module 125 is a non-volatile memory device such as a flash random access memory (“RAM”) or the like. In an alternate embodiment, the memory module 125 is the hard disk drive. In a certain embodiment, the motion summary is stored on both the flash RAM and the hard disk drive. The communication module 130 communicates the motion summary to the analysis module 135. The communication module 130 may include an input/output port such as a serial port, a universal serial bus (“USB”) port, and the like, and a cable such as a serial cable, a USB cable, and the like.

The analysis module 135 makes a business decision based on the motion summary. The analysis module 135 may compare the motion summary to a specified limit and make the business decision according to whether the motion summary exceeds the specified limit. In one embodiment, the business decision is whether to confirm or void a warranty. The analysis module 135 may for example void the warranty if the motion summary exceeds the specified threshold. The system 100 makes a business decision based on a motion summary.

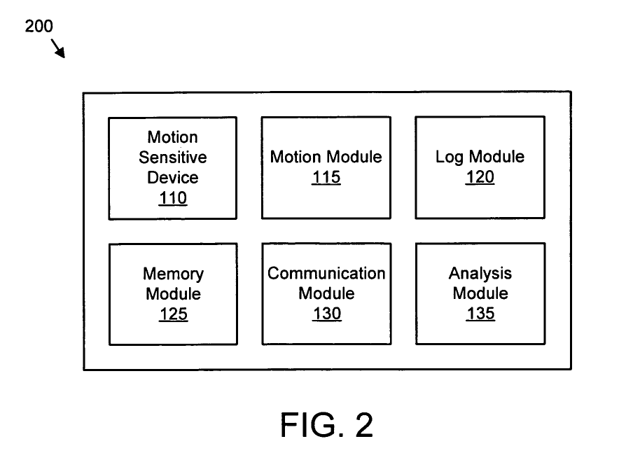

FIG. 2 is a schematic block diagram illustrating one embodiment of a business decision apparatus 200 of the present invention. The apparatus 200 includes a motion module 115, a log module 120, a memory module 125, and an analysis module 135. In one embodiment, the apparatus 200 further comprises a motion sensitive device 110 and a communication module 135.

The motion module 115 is configured to sense a component of motion. The motion component may be acceleration and the motion module may be an accelerometer. In one embodiment, the accelerometer is a discrete device. In an alternate embodiment, the accelerometer is fabricated as a micro-machine using a photolithography process. In a certain embodiment, the motion module 115 is integrated with the log module 120 and the memory module 125.

The log module 120 calculates a motion summary from the motion component. In one embodiment, the log module 120 is configured to detect a major motion event such as a major acceleration event. For example, the log module 120 may detect a major motion event when the motion component exceeds a specified threshold. The log module 120 may calculate the motion summary as the sum of the magnitudes of the major acceleration events. In an alternate embodiment, the log module 120 calculates the motion summary as the sum of the major acceleration events. In a certain embodiment, the log module 120 calculates the motion summary as the presence or absence of a single major motion event.

The memory module 125 stores the motion summary. In one embodiment, the memory module 125 is a non-volatile memory device of a portable electronic device 105 such as a basic input/output system (“BIOS”) flash RAM. In an alternate embodiment, the memory module 125 is dedicated non-volatile memory array and may be integrated with the motion module 115 and the log module 120.

The analysis module 135 makes a business decision based on the motion summary. In one embodiment, the analysis module 135 voids a warranty based on the motion summary. The analysis module 135 may also communicate a damage metric. For example, if the motion summary comprised the sum of magnitudes of major acceleration events, the analysis module 135 may communicate the motion summary as a damage metric. A user may employ the damage metric to estimate potential damage. In a certain embodiment, a communications module 130 communicates the motion summary to the analysis module 135.

For example, the portable electronic device 105 may be a laptop computer and the motion sensitive device 110 may be a hard disk drive. The motion module 115 would sense a motion component such as a twenty-four gravity (24 g) acceleration caused by the impact of a drop. The log module 120 would detect the acceleration as a major acceleration event as the acceleration exceeded a specified threshold of fifteen gravities (15 g). The log module 120 may further calculate the motion summary as the sum of magnitudes of the major acceleration events. If the log module 120 had not detected a previous major acceleration event, the log module would calculate a motion summary of twenty-four cumulative gravities (24 g). The memory module 125 such as a BIOS RAM may store the motion summary.

If the hard disk drive ceased functioning, a user may take the laptop computer for repairs. A technician might connect the laptop computer to an analysis module 135 such as a computer using communications module 130 such as a serial port cable connecting the serial ports of the laptop computer and the computer. The communications module 130 communicates the motion summary of twenty-four cumulative gravities (24 g) from the BIOS RAM to the computer and the computer makes a business decision based on the motion summary. In one example, the computer may void the warranty of the laptop computer based on the motion summary if the motion summary exceeded a specified limit of twenty cumulative gravities (20 g)

In one embodiment, the motion module 115, the log module 120, and the memory module 125 are in continuous operation. For example, if the motion module 115, the log module 120, and the memory module 125 of the apparatus 200 were installed in a laptop computer, the motion module 115, the log module 120, and the memory module 125 may generate and store the motion summary from sensed motion components even while the laptop computer was turned off. Continuous operation allows the analysis module 135 to make a business decision that includes motion events such dropping the laptop computer while the laptop computer is turned off.

In an alternate embodiment, the motion module 115, the log module 120, and the memory module 125 are powered down when the motion sensitive device 110 is powered down. The apparatus 200 may not calculate and store the motion summary for the motion component while the motion sensitive device 110 is powered down because the motion sensitive component is less susceptible to damage from motion while powered down. For example, the hard disk drive of the laptop computer is more susceptible to acceleration damage during operation than when powered down. Hard disk drives are typically placed in a parked state when powered down, making the hard disk drives less susceptible to damage from a drop. The motion module 115, the log module 120, and the memory module 125 may be powered down while the laptop computer is powered down because any motion events are less likely to affect the hard disk drive.

In a certain embodiment, the log module 120 modifies the specified threshold for a major motion event while the motion sensitive device 110 is powered down. For example, the log module 120 employ a specified threshold of about fifteen gravities (15 g) when the motion sensitive device 110 is powered up and further employ a specified threshold of about thirty-five gravities (35 g) when the motion sensitive device 110 is powered down.

In one embodiment, the communication module 130 communicates the motion summary from the memory module 125 to the analysis module 135. The communication module 130 may be communications channel such as a serial bus, a USB bus, a local area network, a wireless network, an infrared communications channel, and the like. In an alternate embodiment, the communications module 130 is a digital bus fabricated as part of a semiconductor device.

The apparatus 200 calculates and stores a motion summary from a sensed motion component and makes a business decision based on the motion summary. The apparatus 200 may be used to detect damage that violates a contract such as warranty, and to modify the contract.

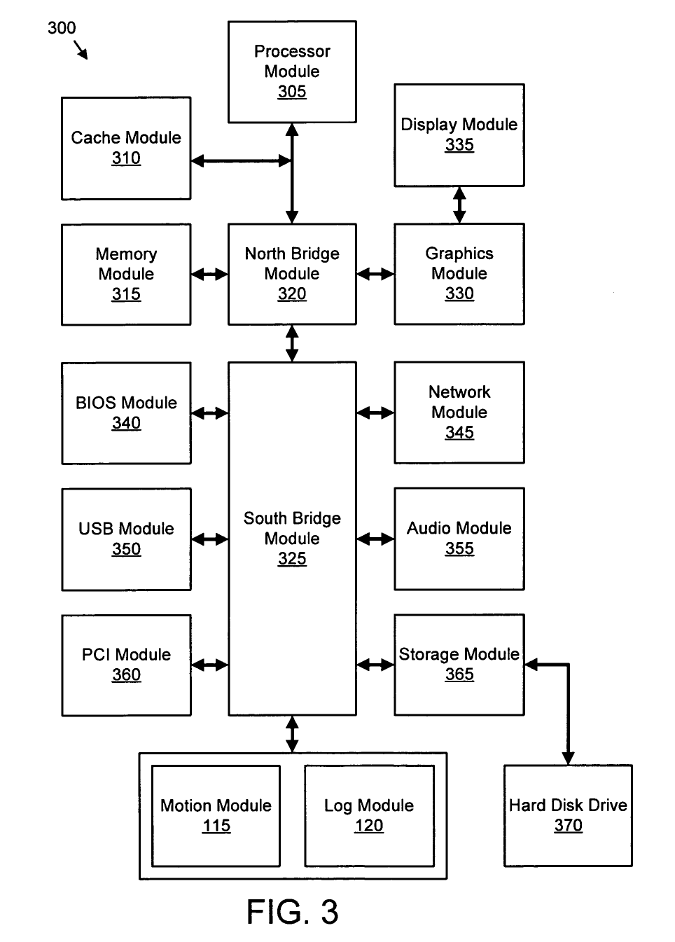

FIG. 3 is a schematic block diagram illustrating one embodiment of a laptop computer 300 of the present invention. The computer 300 includes a processor module 305, a cache module 310, a memory module 315, a north bridge module 320, a south bridge module 325, a graphics module 330, a display module 335, a BIOS module 340, a network module 345, a USB module 350, an audio module 355, a PCI module 360, a storage module 365, a hard disk drive 370, a motion module 115, and a log module 120. The laptop computer 300 functions as is well know by those skilled in the art.

Although the motion module 115 and the log module 120 are in communication with the south bridge module 125, the motion module 115 and log module 120 may be in communication with any element of the computer 300. In the depicted the embodiment, the BIOS module 340 comprises a non-volatile RAM. The BIOS module 340 comprises the memory module 125 as described in FIG. 1. In addition, the hard disk drive 270 comprises the motion sensitive device 110 described in FIG. 1.

In the depicted embodiment, the motion module 115 senses a motion component and the log module 120 calculates a motion summary from the motion component. In one embodiment, the motion module 115 is a piezoelectric accelerometer and the log module 120 is an electronic circuit configured to detect major acceleration events by detecting a voltage threshold. The voltage threshold may correlate to a specified threshold for detecting a major acceleration event. For example, a voltage threshold of fifteen microvolts (15 mV) may correlate to a specified threshold of fifteen gravities (15 g). In a certain embodiment, the log module 120 includes a register to accumulate the motion summary.

The BIOS module 340 stores the motion summary. In one embodiment, the communications module 130 is the USB module 350 and communicates the motion summary to an analysis module 135 external to the computer 300. In an alternate embodiment, the communications module 130 is the north bridge module 320 and the south bridge module 325 and communicates the motion summary to the processor module 305. The processor module 305 may comprise the analysis module 135 and make a business decision based on the motion summary. The analysis module 135 may determine to void a warranty based on a motion summary indicating that the laptop computer 300 has been dropped or put at risk of other motion caused damage.

The following schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors maybe used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

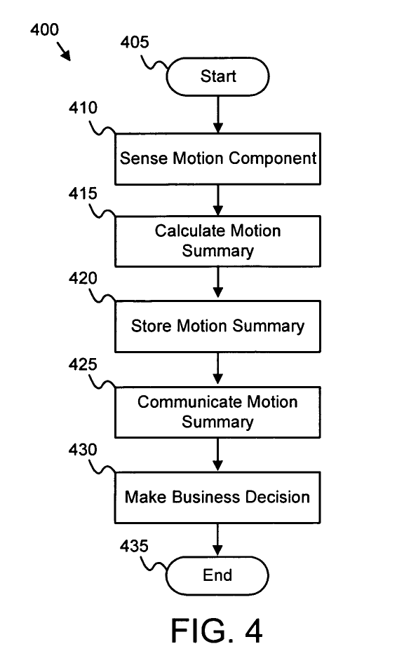

FIG. 4 is a schematic flow chart diagram illustrating one embodiment of a business decision method 400 of the present invention. The method 400 starts 405 and a motion module 115 senses 410 a motion component. In one embodiment, the motion component is acceleration. In an alternate embodiment, the motion component is a derivative of acceleration. For example, the motion module 115 may be a piezoelectric accelerometer and generate a voltage in response to acceleration, wherein the voltage is a function of the acceleration.

A log module 120 calculates 415 a motion summary from the motion component. In one embodiment, the log module 120 receives the voltage from the piezoelectric accelerometer and detects if the voltage exceeds a voltage threshold. If the voltage exceeds the voltage threshold, the log module 120 detects a major acceleration event. The voltage threshold may correlate to a specified threshold. In a certain embodiment the specified threshold is an acceleration of a magnitude likely to cause damage to a motion sensitive device 110. In one embodiment, the specified threshold is in the range between about fifteen gravities (15 g) and about thirty-five gravities (35 g). The specified threshold may be the minimum amount of acceleration at which a motion sensitive device 110 is susceptible to damage. In one embodiment, the log module 120 converts the voltage to a digital magnitude value. The log module 120 may calculate 415 the motion summary as the sum the digital magnitude values of the major acceleration events. In an alternate embodiment, the log module 120 calculates 415 the motion summary as the sum of the major acceleration events. In a certain embodiment, the log module 120 calculates 415 the motion summary as a record of the magnitude of each major acceleration event.

A memory module 125 stores 420 the motion summary. In one embodiment, the memory module is a non-volatile memory device such as the BIOS module 340 of the laptop computer 300. In an alternate embodiment, the memory module 125 is integrated with log module 120. In a certain embodiment, the memory module 125 may comprise both a non-volatile RAM such as the flash RAM of the BIOS module 340 and a storage device such as a hard disk drive. The motion summary may be stored 420 on both the BIOS module 340 and the hard disk drive.

In one embodiment, a communication module 130 communicates 425 the motion summary from the memory module 125 to the analysis module 135. In one embodiment, communication module 130 communicates 425 the motion summary to the analysis module 135 when the analysis module 135 queries the memory module 125. For example, a wireless network controller may query the memory module 125 of a cellular telephone for a motion summary and the cellular telephone may communicate 425 the motion summary over the wireless network.

In an alternate embodiment, the motion summary is stored on a hard disk drive and the communication module 130 communicates 425 the motion summary from the hard disk drive to the analysis module 135. For example, the communication module 130 may comprise a hard disk drive interface. The hard disk drive may be removed from a portable electronic device 105 such as for service. The communication module 130 may communicate 425 the motion summary from the hard disk drive to the analysis module 135.

In a certain embodiment, the log module 120 directs the communication module 130 to communicate 425 the motion summary to the analysis module 135 when the motion summary exceeds a specified level. For example, the log module 120 of a portable medical device may determine the motion summary exceeds a specified level and communicate 425 the motion summary through a wireless local area network to an analysis module 135 such as a server.

The analysis module 135 makes 430 a business decision based on the motion summary, and the method 400 terminates. In one embodiment, the business decision is to void a warranty. In an alternate embodiment, the business decision is to take a portable electronic device 105 out of service. For example, if a motion summary indicates acceleration in excess of a specified limit, the analysis module 135 may make 430 the business decision of taking a portable electronic device 105 such as a portable medical device out of service. The method 400 makes 430 a business decision based on a motion summary calculated 415 from a sensed 410 motion component.

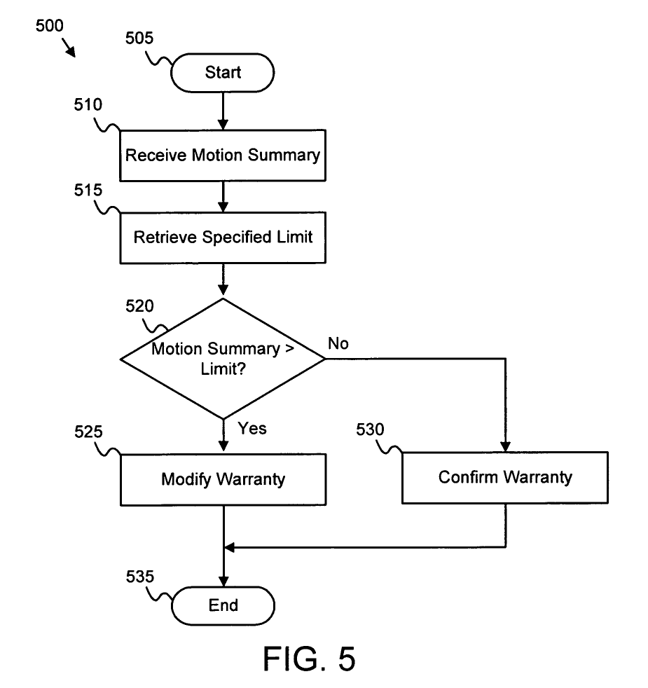

FIG. 5 is a schematic flow chart diagram illustrating one embodiment of a motion summary evaluation method 500 of the present invention. In one embodiment, the method 500 comprises making 430 a business decision as depicted in FIG. 4. The method 500 starts 505 and an analysis module 135 receives 510 a motion summary. The analysis module 135 may be a diagnostic computer, a server, or the like. In an alternate embodiment, the analysis module 135 is comprised in a portable electronic device 105 with the motion module 115, the log module 120, and the memory module 125. In one embodiment, the motion summary is the sum of major acceleration events. In an alternate embodiment, the motion summary is the sum of the magnitudes of major acceleration events. In a certain embodiment, the motion summary is a list of the magnitudes of the major acceleration events.

The analysis module 135 further receives 515 a specified limit. In one embodiment, the specified limit is a number of instances of major acceleration events. For example, the specified limit may be one (1) major acceleration event. In an alternate embodiment, the specified limit is a magnitude of cumulative acceleration. For example, the specified limit may be a magnitude of cumulative acceleration of seventy gravities (70 g). In a certain embodiment, the specified limit is one or more rules that may be applied to a list of magnitudes of major acceleration events and indicate if the list exceeds the rule. The analysis module 135 may receive 515 the specified limit from a user or over a network.

The analysis module 135 determines 520 if the motion summary exceeds the specified limit, making a business decision based on the determination. In one embodiment, if the motion summary exceeds the specified limit, the analysis module 135 modifies 525 a warranty and terminates 535 the method 500. For example, the analysis module 135 may modify 525 a warranty by communicating that the warranty is void. In an alternate example, the analysis module 135 modifies 525 the warranty by setting a repair or replacement price based on the motion summary.

In one embodiment, if the motion summary does not exceed the specified limit, the analysis module 135 confirms 530 the warranty. For example, the analysis module 135 may confirm 530 the warranty by communicating a manufacturers commitment to cover a portable electronic device 105 by one or more warranty terms.

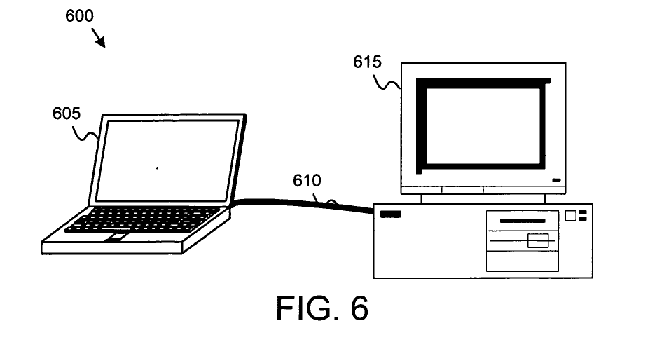

FIG. 6 is front view drawing of a communication system 600 of the present invention. A laptop computer 605 such as a laptop computer 605 with a malfunctioning hard disk drive 370 is in communication with a computer 615 such as a diagnostic computer over a serial port connection 615. The diagnostic computer 615 comprises the analysis module 135. The laptop computer 605 comprises a memory module 125 configured with a motion summary as well as the motion module 115 and the log module 120. The analysis module 135 of the computer 615 retrieves 510 the motion summary from the memory module 125 and retrieves 515 a specified limit from the laptop manufacturer's Internet web site. The analysis module 135 determines 520 if the motion summary exceeds the specified limit and makes a business decision 430 based on the determination 520. For example, the analysis module 135 may specify an acceptable valve for replacement cost of the laptop computer 605 based at least partially on the motion summary.

The present invention is the first to allow a manufacturer to make a business decision such as modifying warranty terms based on the damage that may have been caused by motion such as acceleration due to an impact from a drop that is not covered by a warranty or taking a portable electronic device 105 out of service if the device 105 is a risk of failure due to motion damage. The present invention is novel in making a business decision based on motion data calculated and stored as a motion summary.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to make a business decision, the apparatus comprising:
a motion module configured to sense a motion component;
a log module configured to calculate a motion summary from the motion component;
a memory module configured to store the motion summary; and
an analysis module configured to make a business decision based on the motion summary.

2. The apparatus of claim 1, wherein the motion module is an accelerometer and the motion component is acceleration.

3. The apparatus of claim 2, wherein the log module is configured to detect a major acceleration event that exceeds a specified threshold.

4. The apparatus of claim 3, wherein the log module calculates the motion summary as the sum of the magnitudes of major acceleration events.

5. The apparatus of claim 3, wherein the log module calculates the motion summary as the sum of the major acceleration events.

6. The apparatus of claim 3, wherein the specified threshold is an acceleration of a magnitude likely to cause damage to a motion sensitive device.

7. The apparatus of claim 1, further comprising a communication module configured to communicate the motion summary from the memory module to the analysis module.

8. The apparatus of claim 7, wherein the communications module comprises an input/output port.

9. The apparatus of claim 1, further comprising a hard disk drive.

10. The apparatus of claim 1, wherein the business decision comprises modifying a warranty.

11. A device to measure damage, the apparatus comprising:
a motion module configured to sense a motion component;
a log module configured to calculate a motion summary from the motion component;
a memory module configured to store the motion summary; and
an analysis module communicate a damage metric responsive to the motion summary wherein the damage metric is used to make a business decision.

12. A system to make a business decision, the system comprising:
a motion sensitive device;
a motion module configured to sense a motion component;
a log module configured to calculate a motion summary from the motion component;
a memory module configured to store the motion summary;
a communication module configured to communicate the motion summary from the memory module; and
an analysis module configured to make a business decision based on the motion summary.

13. The system of claim 12, wherein the motion sensitive device is a hard disk drive.

14. The system of claim 12, further comprising a laptop personal computer.

15. The system of claim 12, further comprising a cellular telephone.

16. The system of claim 12, wherein the memory module comprises a hard disk drive.

17. The system of claim 12, wherein the memory module comprises a non-volatile random access memory device.

18. A signal bearing medium tangibly embodying a program of machine-readable instructions executable by a digital processing apparatus to perform operations to make a business decision, the operations comprising:
sensing a motion component;
calculating a motion summary from the motion component;
storing the motion summary; and
making a business decision based on the motion summary.

19. The signal bearing medium of claim 18, wherein the motion component is acceleration.

20. The signal bearing medium of claim 19, wherein the instructions further comprise operations to detect a major acceleration event that exceeds a specified threshold.

21. The signal bearing medium of claim 20, wherein the instructions further comprise operations to sum the magnitudes of major acceleration events as the motion summary.

22. The signal bearing medium of claim 20, wherein the instructions further comprise operations to sum the major acceleration events as the motion summary.

23. The signal bearing medium of claim 20, wherein the specified threshold is an acceleration of a magnitude likely to cause damage to a motion sensitive device.

24. The signal bearing medium of claim 18, wherein the instructions further comprise operations to modify a warranty in response to the motion summary.

25. The signal bearing medium of claim 18, wherein the instructions further comprise operations to record the motion summary in a data store.

26. A method for making a business decision, the method comprising:
sensing a motion component;
calculating a motion summary from the motion component;
storing the motion summary; and
making a business decision based on the motion summary.

27. The method of claim 26, wherein the motion component is acceleration and further comprising detecting a major acceleration event that exceeds a specified threshold.

28. The method of claim 27, further comprising summing the magnitudes of the major acceleration events as the motion summary.

29. The method of claim 27, further comprising summing the major acceleration events as the motion summary.

30. An apparatus to making a business decision, the apparatus comprising:
means for sensing a motion component;
means for calculating a motion summary from the motion component;
means for storing the motion summary; and
means for making a business decision based on the motion summary.
